(19) United States
(12) Patent Application Publication
(10) Pub. No.: US 2021/0146741 A1
(43) Pub. Date: May 20, 2021

(54) Friction Free Roller Spring Perch

(71) Applicant: John Dinkel, Carmel Valley, CA (US)

(72) Inventor: John Dinkel, Carmel Valley, CA (US)

(21) Appl. No.: 16/688,161

(22) Filed: Nov. 19, 2019

(51) Int. Cl. B60G 15/06

(52) U.S. Cl. CPC B60G 15/063; B60G 2204/1242; B60G 2206/601; B60G 2206/811; B60G 2206/8201; B60G 2206/82092

(57) ABSTRACT

A method for constructing a roller spring perch has steps for cutting holes through sides of a spring perch bracket along an axis at a right angle to the sides of the bracket, cutting a tube having an outside diameter substantially the same as an inside diameter of the holes cut through the sides of the bracket, to a length longer than a dimension across the sides of the bracket, counterboring the tube from each end to an inside diameter and a length to accommodate roller bearings, and inserting the tube through the holes in the sides of the bracket, and spot welding the tube in place.

### BACKGROUND OF THE INVENTION

### 1. Field of the Invention

The present invention is in the technical area of automotive suspension and pertains mare particularly to perch apparatus for engaging compression springs and shock absorbers in suspension systems.

### 2. Description of Related Art

Spring perches are known in the art, and are apparatus having an interface for nesting one end of a compression spring and a shock absorber within the compression spring, the apparatus on a pivot mounted to a lower control arm in an automobile suspension system. The spring perch rotates to compensate for changing alignment of elements as a suspension system operates. An axle through the spring perch provides rotation, and the axle is mounted to the lower control arm.

A spring perch is known in the art with bearings in housings to provide free rotation about the axle mounted to the control arm, but the bracket for the spring perch has bearing housings that are quite large in diameter, and separate in the apparatus, and manufacture of this prior art spring perch is difficult, time-consuming and expensive.

What is clearly needed in the art is a spring perch that provides housing for roller bearings, but is simpler, and comparatively inexpensive to manufacture.

### BRIEF SUMMARY OF THE INVENTION

In one embodiment of the invention a method for constructing a roller spring perch is provided, comprising steps of cutting holes through sides of a spring perch bracket along an axis at a right angle to the sides of the bracket, cutting a tube having an outside diameter substantially the same as an inside diameter of the holes cut through the sides of the bracket, to a length longer than a dimension across the sides of the bracket, counterboring the tube from each end to an inside diameter and a length to accommodate roller bearings and inserting the tube through the holes in the sides of the bracket, and spot welding the tube in place.

In one embodiment the method further comprises press fitting roller bearings into the counterbores, passing a shaft having retainer grooves through the bearings, and installing retainer clips in the grooves to retain the bearings.

In another aspect of the invention a frame for a roller spring perch is provided, comprising a bracket having a first region for interfacing to a compression spring and to a shock absorber within the compression spring, a first side extending at a right angle to the first region along a first edge of the first region, and a second side extending at a right angle to the first region along a second edge of the first region, the first and second sides parallel, holes through the first and second sides along an axis at a right angle to the sides, and a tube of a length greater than a dimension across the first and second sides of the bracket, the tube inserted through the holes in the sides of the bracket, centered on the bracket and affixed to the sides of the bracket.

In one embodiment the tube is affixed by spot welding to the sides of the bracket. In one embodiment the frame further comprises counterbores from each end of the tube of an inside diameter to accommodate roller bearings.

In another aspect of the invention a roller spring perch is provided, comprising a bracket having a first region for interfacing to a compression spring and to a shock absorber within the compression spring, a first side extending at a right angle to the first region along a first edge of the first region, and a second side extending at a right angle to the first region along a second edge of the first region, the first and second sides parallel, and holes through the first and second sides along an axis at a right angle to the sides, a tube of a length greater than a dimension across the first and second sides of the bracket, the tube inserted through the holes in the sides of the bracket, centered on the bracket and affixed to the sides of the bracket, the tube having counterbores from each end of a depth and diameter to accommodate roller bearings, roller bearings press fit into the counterbores from each end, and a shaft though the bearings, extending a common distance on each side from the outer end of the bearings, ending in a fastener interface for mounting the roller spring perch in an automotive suspension system.

### BRIEF DESCRIPTION OF THE SEVERAL VIEWS OF THE DRAWINGS

FIG. 1 is perspective view of a spring perch mounted on a lower control arm in an embodiment of the present invention.

FIG. 2 is a perspective view of a spring perch on a lower control arm in context with other elements of an automotive suspension system.

FIG. 3 is a perspective view of spring perch as existing in the prior art.

FIG. 4 is a perspective view of a roller spring perch in an embodiment of the present invention.

FIG. 5 is a perspective view of a bracket and tube assembly at one stage in making a spring perch according to the invention.

FIG. 6 is a plan view of the bracket and tube assembly of FIG. 5.

FIG. 7 is a perspective view of the tube in the view of FIGS. 5 and 6.

### DETAILED DESCRIPTION OF THE INVENTION

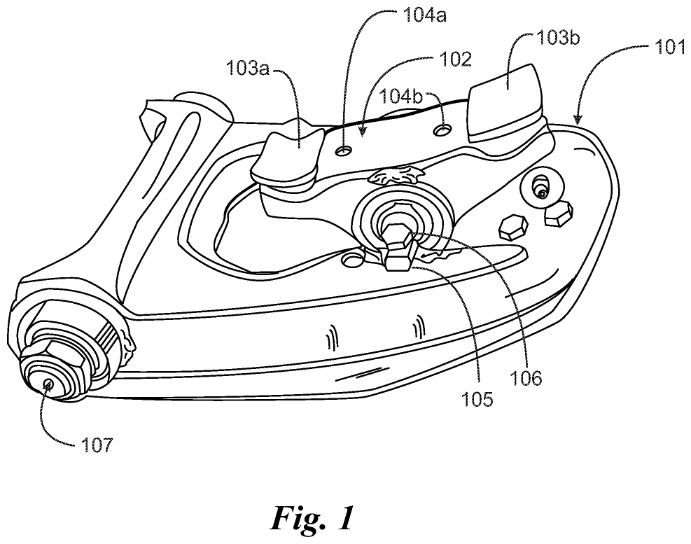

FIG. 1 is perspective view of a spring perch 102 mounted on a lower control arm 101 in an embodiment of the present invention. Spring perch 102 is a rocker assembly rotatable about an arm 105 that passes through bearings in the spring perch. Arm 105 is bolted in this example to the lower control arm 101 by bolts 106 seen on one side, hidden on the other side. The spring perch has pads 103a and 103b to accept opposite sides of a large compression spring in the suspension system, and holes 104a and 104b are for securing a lower end of a shock absorber in the suspension system. It may be seen, as is conventional, that the lower control arm 101 rotates as a cantilever about an axis 107, which axis extends in the direction of travel of the automobile for which the suspension system serves. The axis of arm 105, about which the roller spring perch rotates is parallel to the axis of the lower control arm. As the lower control arm changes angle, the roller spring perch does as well, compensating for misalignment.

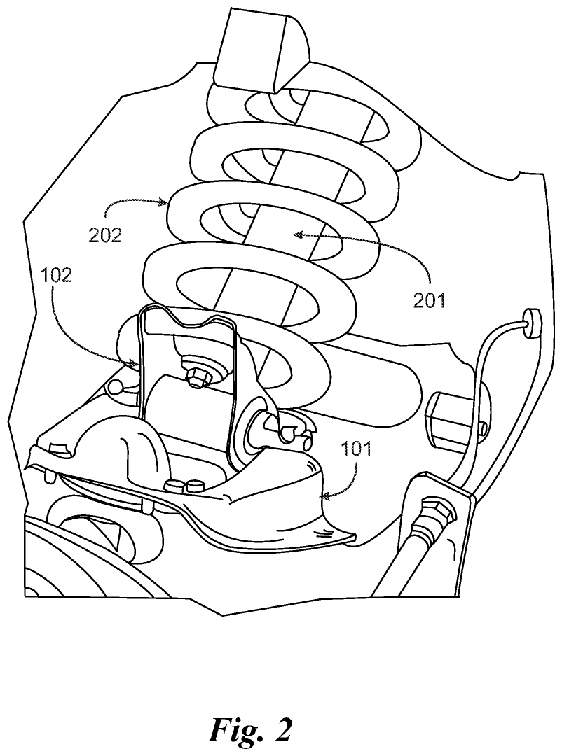

FIG. 2 is a perspective view of spring perch 102 and lower control arm 101 of FIG. 1 in context with other elements of an automotive suspension system. In this example compression spring 202 and shock absorber 201 are shown as they interact with the spring perch and lower control arm. FIG. 2 is intended to provide further understanding of the role of the spring perch and the lower control arm in the suspension.

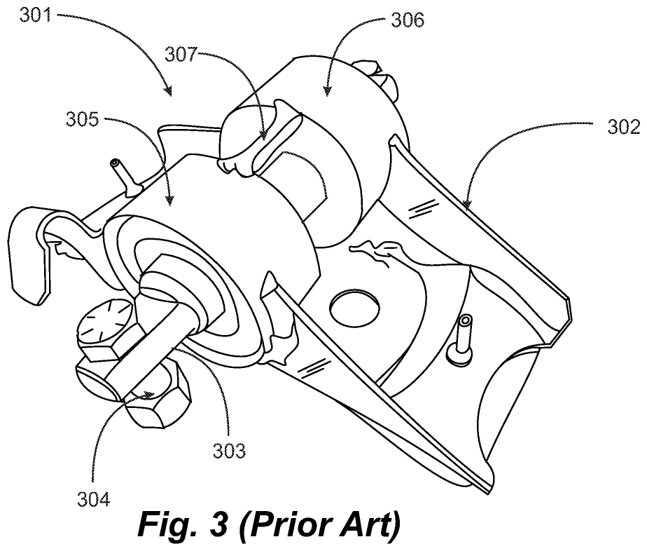

It was stated above in the Background section that roller spring perches are not necessarily new in the art. FIG. 3 is a perspective view of roller spring perch 301 as existing in the prior art, made commercially available by a company named OpenTrackerRacing, of Carmel Valley, Calif. It may be seen that roller spring perch 301 has a bracket 302, which provides mounting positions for pads for opposite sides of an end of a large compression spring, as shown in FIG. 2, and holes for securing to an end of a shock absorber. In the example of FIG. 3 two separate, large diameter bearing housings, 305 and 306 are welded into the bracket. Bearings are mounted in each of housing 305 and 306, and arm 303 is part of an axle that passes all the way through the bearings in both bearing housings. In this example bearing housings 305 and 306 are joined by a welded in strut 307 for strength and stability.

In manufacturing and assembly of the prior art roller spring perch as shown in FIG. 3, the inventor became convinced that there had to be a better and less expensive way to implement the roller spring perch.

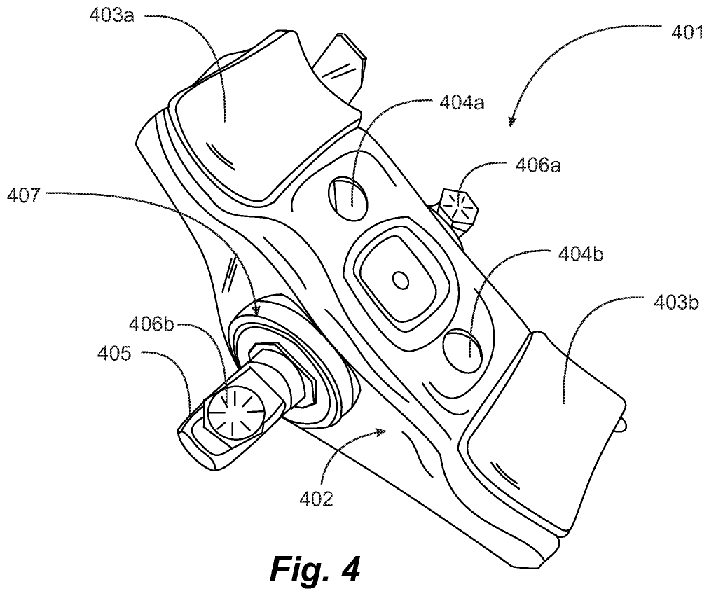

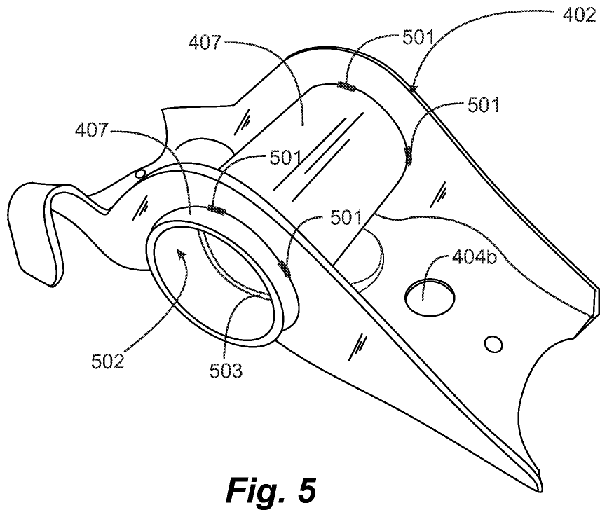

FIG. 4 is a perspective view of a roller spring perch 401 in an embodiment of the present invention. Spring perch 401 has a steel bracket 402 which may be the same bracket upon which prior art spring perch 301 is implemented. The bed of the bracket is the same as in the prior art apparatus, providing seats for pads 403a and 403b to accept opposite sides of an end of a large compression spring. Hole 404a and 404b are common to the prior art apparatus as well, for securing to one end of the shock absorber. In the example of FIG. 4, however, bearing housing is accomplished within an inside diameter of a single tube 407 that passes through bracket 402 side-to-side. Tube 407 is counterbored, as shown below with reference to FIGS. 5, 6 and 7, to provide seating for two roller bearings upon which the shaft of arm 405 turns. Bolts 406a and 406b are bolts, passing through flattened ends of shaft 405 to secure the roller spring perch to the lower control arm.

FIG. 5 is a perspective view of a bracket and tube assembly at one stage in making a spring perch according to the invention. FIG. 5 shows bracket 402 inverted to be seen from below and shows tube 407 passing through both sides of bracket 402. The bracket is bored on both sides with holes of inside diameter substantially equal to the outside diameter of tube 407. The tube is inserted, and spot welded at points 501 in this example, extending a short dimension outside the sides of the bracket on each side, as shown.

Tube 407, prior to assembly to the bracket, is counterbored on each end to an inside diameter 502 to a set depth to a shoulder 503. The diameter of this counterbore is controlled to provide a press fit for bearings that will be assembled after the tube is welded in the bracket. In an alternative embodiment the bearings may be press fit before the tube is welded through the bracket.

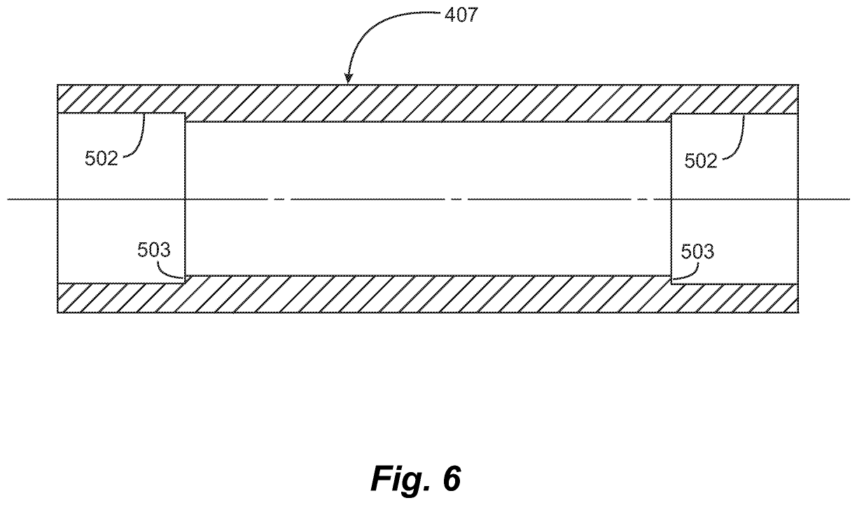

FIG. 6 is a section view of tube 407, showing counterbores 502 and shoulders 503 at each end of the tube. In process of manufacture a roller bearing is inserted and pressed into the counterbore from each end. A shaft 405 (see FIG. 4) has retainer grooves, not shown, at positions for accepting clips that hold the assembly together one the shaft is inserted through the bearings and the retainer clips are inserted.

The implementation of a single tube, spot welded through the bracket as detailed in FIGS. 5 and 6, reduces the material and labor cost in manufacture by at least fifty percent and results in a simpler product as well.

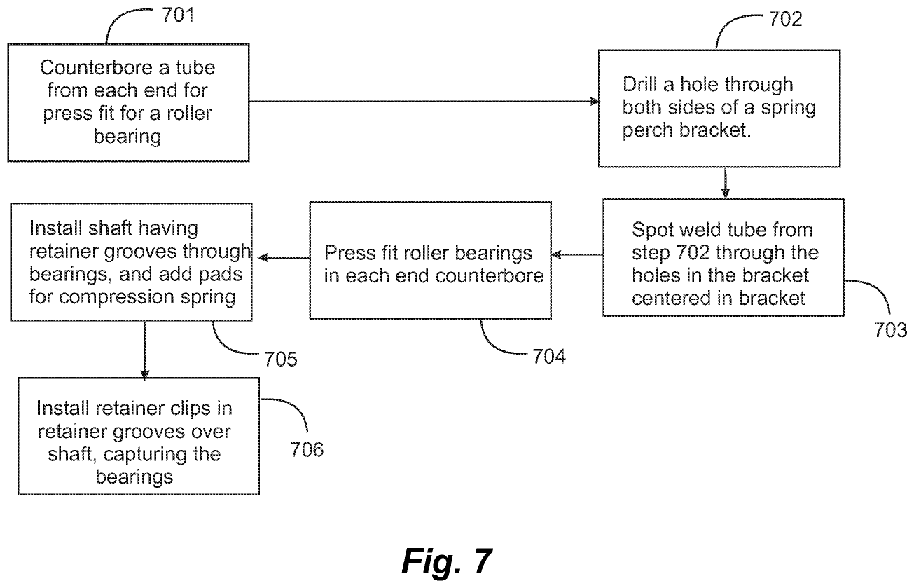

FIG. 7 is a flow diagram illustrating a method for constructing a roller spring perch. At step 701 a tube of sufficient length for a particular spring perch is counterbored from each end with an inside diameter for the bore to accomplish a press fit for roller bearings to be used for the roller spring perch under construction. At step 702 holes are drilled through both sides of a spring perch bracket. The bracket may be a new bracket, or a bracket retrieved from a prior art spring perch.

At step 703 the tube is inserted through the holes made in step 703, and spot welded to the bracket, centered through the bracket. At step 704 roller bearings are press fit into the counterbores from each end of the tube. Alternatively, the bearings may be press fit into the tube before the tube is spot welded through the bracket. At step 705 a shaft having retainer groves is inserted through the bearings and pads are added to interface to the compression spring. Retainer clips are inserted to the grooves in the shaft at step 706 to retain the bearings in the tube.

A person of ordinary skill in the art will understand that the embodiments described above with reference to the drawing figures are exemplary, and not limiting. There may well be other ways that the roller spring perch of the invention may be implements within the scope of the invention. The invention is limited only by the claims that follow.

I claim:

1. A method for constructing a roller spring perch, comprising steps of:
cutting holes through sides of a spring perch bracket along an axis at a right angle to the sides of the bracket;
cutting a tube having an outside diameter substantially the same as an inside diameter of the holes cut through the sides of the bracket, to a length longer than a dimension across the sides of the bracket;
counterboring the tube from each end to an inside diameter and a length to accommodate roller bearings; and
inserting the tube through the holes in the sides of the bracket, and spot welding the tube in place.

2. The method of claim 1 further comprising;
press fitting roller bearings into the counterbores;
passing a shaft having retainer grooves through the bearings; and
installing retainer clips in the grooves to retain the bearings.

3. A frame for a roller spring perch, comprising:
a bracket having a first region for interfacing to a compression spring and to a shock absorber within the compression spring, a first side extending at a right angle to the first region along a first edge of the first region, and a second side extending at a right angle to the first region along a second edge of the first region, the first and second sides parallel;
holes through the first and second sides along an axis at a right angle to the sides; and
a tube of a length greater than a dimension across the first and second sides of the bracket, the tube inserted through the holes in the sides of the bracket, centered on the bracket and affixed to the sides of the bracket.

4. The frame of claim 4 wherein the tube is affixed by spot welding to the sides of the bracket.

5. The frame of claim 4 further comprising counterbores from each end of the tube of an inside diameter to accommodate roller bearings.

6. A roller spring perch comprising:
a bracket having a first region for interfacing to a compression spring and to a shock absorber within the compression spring, a first side extending at a right angle to the first region along a first edge of the first region, and a second side extending at a right angle to the first region along a second edge of the first region, the first and second sides parallel, and holes through the first and second sides along an axis at a right angle to the sides;
a tube of a length greater than a dimension across the first and second sides of the bracket, the tube inserted through the holes in the sides of the bracket, centered on the bracket and affixed to the sides of the bracket, the tube having counterbores from each end of a depth and diameter to accommodate roller bearings;
roller bearings press fit into the counterbores from each end; and
a shaft though the bearings, extending a common distance on each side from the outer end of the bearings, ending in a fastener interface for mounting the roller spring perch in an automotive suspension system.
